(19) United States
(12) Patent Application Publication
(10) Pub. No.: US 2013/0092032 A1
(43) Pub. Date: Apr. 18, 2013

(54) INTELLIGENT HOME COOKING APPLIANCE, ASSOCIATED SYSTEMS, AND/OR METHODS

(71) Applicants: Alicia Cafferty, Westminster, CA (US); John Farley, San Clemente, CA (US); Claudia Häpp, Munchen (DE); Benjamin King, New Bern, NC (US); Jürgen Riesmeyer, Penzberg (DE)

(72) Inventors: Alicia Cafferty, Westminster, CA (US); John Farley, San Clemente, CA (US); Claudia Häpp, Munchen (DE); Benjamin King, New Bern, NC (US); Jürgen Riesmeyer, Penzberg (DE)

(73) Assignee: BSH HOME APPLIANCES CORPORATION, Huntington Beach, CA (US)

(21) Appl. No.: 13/275,368

(22) Filed: Oct. 18, 2011

(51) Int. Cl. A47J 37/00

(52) U.S. Cl. 99/325

(57) ABSTRACT

The technology disclosed herein relates to intelligent home/residential cooking appliances and interactive content that is interpretable to send instructions to such intelligent cooking appliances, as well as associated systems and/or methods for generating and/or processing the same. In certain instances, an intelligent home/residential appliance may receive and/or display the content for a user and, at appropriate times, possibly prompt a user to take actions or automatically take appropriate actions for the user. Such activities advantageously may prompt a user in some examples to more actively participate in, and/or interact with, a cooking show or program. A user therefore may be more immersed in a cooking experience and feel more comfortable trying out new recipes, given the expectation that the cooking appliance itself may help to resolve problems as they arise and/or suggest solutions to detected abnormalities.

### TECHNICAL FIELD

The technology disclosed herein relates to intelligent home cooking appliances, associated systems, and/or methods. More particularly, the technology disclosed herein relates to intelligent home cooking appliances and interactive content that is interpretable to send instructions to such intelligent home cooking appliances. In certain instances, an intelligent home appliance may receive and/or display the content for a user and, at appropriate times, possibly prompt a user to take actions or automatically take appropriate actions for the user. Such activities advantageously may prompt a user in some examples to more actively participate in, and/or interact with, a cooking show or program or other media.

### BACKGROUND AND SUMMARY

Cookbooks quite often are staple items in kitchens, at both in-home and out-of-home (e.g., restaurant, hotel, etc.) locations, for a variety of personal, amateur, and professional undertakings. A cookbook is indeed an efficient vehicle for conveying a potentially large amount of valuable information to a cook, whether that information is a specific recipe with detailed listings of ingredients, amounts, and cooking instructions; general tips and tricks about cooking a certain type of food or employing a particular cooking technique; or some other useful bit of knowledge. Thousands of cookbooks directed to different types of cuisine, regional specialties, courses, types of meat, vegetarian and vegan treats, etc., are available.

Although cookbooks can be informative, they also have limitations, e.g., given their static word-on-paper formats. A cookbook might, for instance, take for granted the level of skill of the individual chef using the cookbook. For example, although most cooks would know how to dice a tomato, some cooks might not be familiar with the different techniques for stewing tomatoes quickly and efficiently. As another example, a cookbook might instruct a cook to cook something until it is reduced, without ever explaining what a reduction is or without providing a corresponding visual indication. Even the book entitled “How to Cook Everything” cannot prepare a cook for every possible variation, technique, or instruction that one might encounter in a real-world in-home scenario.

Cooking shows are available on broadcast and cable television, e.g., for viewers at home. The popularity of cooking channels, “reality television” cooking shows, and the like, demonstrate that such programming is popular among at least some home audiences. Part of the draw of cooking shows is perhaps that they provide clear instructions and visual indications as to what actions to take, when such actions are to be taken, how they can be accomplished, when they are finished, etc. Similar to cookbooks, there are a number of different cooking shows directed to different types of cuisine, regional specialties, courses, types of meat, vegetarian and vegan treats, etc. A cook at home might feel comfortable following instructions from a particular celebrity chef for a particular type of food and thus may watch a corresponding television program.

Although cooking programs are popular, they still leave something to be desired. Compared to cookbooks, for example, there are a limited number of cooking programs available at a given time. One cannot tune in a cooking program or browse through a vast library of cooking programs in the ways that a chef at home can pickup an old favorite recipe or simply page through a number of cookbooks until a meal that looks appetizing appears. Even when shows purporting to involve cuisine of a desired quality are available, there is no guarantee that the actual dish will be something that the cook at home wants to make. Another issue with cooking shows is their limited duration. Oftentimes, a chef on a cooking show will instruct a cook at home to pre-heat an oven, boil an item in water for a certain number of minutes, bake at a given temperature for a time period, etc., all of which takes time. To compensate for the limited amount of time, celebrity chefs may have started cooking before the show actually began to air and thus will pull out the end-product. In the meantime, however, cooks at home might not have a way of pausing the show while they accomplish their own tasks. When a particularly difficult or involved task is to be accomplished, cooks at home also might not be able to rewind and re-watch the demonstration or even keep pace with actions that many celebrity cooks find routine and can accomplish quickly.

Of course, both cookbooks and cooking shows are limited in their abilities to provide for interactive experiences for the cooks. Cookbooks are typically just on paper (or text on a screen) with limited still pictures, and cooking shows are broadcast to televisions (or computers) without allowing cooks at home to interrupt or ask questions. In both situations, there also is the chance for error if a cook at home is inattentive, misses a step, lets an item bake for too long and/or at too high of a temperature, etc.

Thus, it will be appreciated that it would be desirable to provide for a more interactive cooking demonstration. For instance, it will be appreciated that it would be desirable to provide a large variety of audiovisual cooking program content to home users. It also will be appreciated, for instance, that it would be desirable to provide an interactive cooking program that provides an avenue for cooks to ask questions and reduces the chance of home cook error.

One aspect of certain example embodiments of this invention relates to an automatic cooking program that is fed with data from a cooking video and that triggers appropriate appliance activities and/or user interactions, e.g., at a remote home location.

Another aspect of certain example embodiments of this invention relates to a cooking appliance that reacts to incoming data from “smart cooking programs” that include videos that have been annotated with instructions so as to cause appropriate actions on the part of the appliance and/or displays associated therewith, even though the cooking appliance may be at a location (e.g., in a home) that is remote from place(s) the smart cooking programs are generated and/or transmitted.

As an example, a suitably configured oven (e.g., in a home location) may receive data from a live cooking program taking place at a remote location or from a pre-recorded cooking program. The appropriate data set may be accessed by the oven and played back to an end-user on a display on or in close relative proximity to the oven (e.g., on a free-standing display, personal computer, smart phone, tablet, or the like, that has a data connection to the oven). At various points during the cooking program, intervention by the user may be necessary, e.g., to turn over the item to be cooked, etc. At such points, the user may be alerted to take the appropriate action, e.g., via an audio and/or visual signal. Further actions, such as changing the temperature, changing the heating mode, supplying steam, etc., may be accomplished by the appliance with or without direct human intervention, based on the incoming data.

In contrast with fixedly defined online video clips, television programs, and traditional cookbooks, and the like, the above-described interactions may be structured as flexible programs. Depending on the recipe selected by the end-user, the appliance may react accordingly and/or provide hints as to when manual intervention is necessary or desirable. This sort of interactivity may be particularly advantageous in home or residential setting where a more individualized and participatory experience can be created for a particular home or residential user cooking a particular dish as opposed to, for example, commercial mass-production environments where there is little or no individual attention or participatory action required or even desired. That is, in contrast with commercial mass-production environments where homogeneity across a product is of increased importance, certain aspects of the invention help create a more customized and/or individualized cooking experience for users. Such a customized and/or individualized cooking experience may helps convey a sense of immersion through active participation and/or feedback, while also providing a sense of security potentially encouraging cooks to branch out into new and unexplored cooking avenues and/or avenues where failure was previously anticipated or even encountered. The perception of individualized attention spurring individualized creations fostered by certain forms of the invention is readily contrastable with typical commercial environments where even modest variations are undesirable and frequently to be avoided. These challenges, problems, aspects, etc., simply do not apply to factory environments.

In certain forms of the invention, a cooking appliance (e.g., for home or residential use) is provided. One or more controls is/are operable by a user to adjust settings of the cooking appliance. A display is provided. Processing resources include at least one processor configured to: present a user interface to the user using the display, access a cooking program distributable based on a user selection from the user interface, obtain video and/or audio content and at least one instruction from the cooking program distributable, cause the video and/or audio content obtained from the cooking program distributable to be displayed on the display or output to speakers, and control the cooking appliance in response to the instructions.

In certain instances, each instruction may specify an action to be taken by a user and a time at which the action is to be taken. The time at which the action to be taken is specifiable as either an absolute time reference linked to the video content, or a variable time based on a condition of the cooking appliance and/or item to be cooked. For instance, the variable time may be based on a calculation.

In certain instances, each instruction may specify whether a user must act based on the instruction. In certain of such cases, a consequence of a user not acting in response the instruction within a specified time period also may be specified. In certain of such cases, the consequence may include an instruction to the at least one processor of the cooking appliance to adjust one or more settings thereof to reduce or otherwise mitigate the likelihood of damage to an item being cooked or a reminder to the user to take the specified action.

In certain instances, the at least one processor may be further configured to generate an audible and/or visual alert each time an action is to be taken or is overdue to be taken.

In certain instances, the at least one processor may be further configured to adjust one or more settings of the cooking appliance without direct human intervention in the event that the action to be taken by the user is not taken within a specified time limit. For instance, the at least one processor may be further configured to adjust the one or more settings of the cooking appliance that would have been adjusted if the user had taken action in accordance with the instruction.

In certain instances, the user interface may include an input area through which the user is able to send a message (e.g., an email, text, multimedia, or other message) to a remote site, for possible answering, help, feedback, rating, comment, and/or other purposes.

In certain forms of the invention, a cooking system (e.g., for home or residential use) is provided. At each of a plurality of home locations there may be provided: a cooking appliance operable by a user; a display device operably connectable to the cooking appliance and configured to display a user interface; a network communications device configured to obtain cooking video content and associated cooking instructions from a remote location over a network connection to a network in response to a user selection from the user interface; a display controller configured to cause the video content obtained by the network communications device to be output to the display device; and a command parser configured to interpret the associated cooking instructions so that the associated cooking instructions are selectively (a) output to the display device and (b) used to control the cooking appliance.

In certain instances, each home location may include a central house manager connecting the cooking appliance and/or display device to the network. The central house manager may in certain scenarios include the command parser and/or display controller.

In certain instances, a server may be located remote from the home locations and may be connected to each of the home locations via the network. The server may store a plurality of downloadable cooking programs, with each said cooking program storing related cooking video content and associated cooking instructions. The network communications device of each cooking appliance may be configured to access individual ones of the cooking programs.

In certain instances, cooking programs may be downloadable, streamable, and/or otherwise accessible to the cooking appliances. Thus, it may be possible to retroactively embed code in or associate code with existing programs.

In certain forms of the invention, there is provided a non-transitory computer readable storage medium. The medium tangibly stores instructions that, when executed or interpreted, cause a cooking appliance (e.g., at a home, residential, or other location) to at least: display a video segment on a display device in operable communication with the cooking appliance; display, on the display device, one or more recipe steps to a user of the cooking appliance at time periods specified by the instructions; and selectively override one or more settings of the cooking appliance if the user does not act in accordance with a command included in the instructions within a time period specified by the instructions.

In certain instances, the instructions may be stored in a tag-based format (e.g., in an XML file).

In certain forms of the invention, a method of controlling a cooking appliance (e.g., at a home, residential, or other location) is provided. A request for a cooking program from the cooking appliance is received. The request for the cooking program is matched with a corresponding cooking program distributable, with the cooking program distributable including video content and instructions as to how the cooking appliance is to be operated. The corresponding cooking program distributable is sent to the cooking appliance. The cooking appliance is configured to process the cooking program so as to (a) cause the video content to be displayed thereon, and (b) control the cooking appliance in accordance with the instructions.

In certain instances, each instruction may specify at least one of an action to be taken by a user, a time at which the action is to be taken, an indication of whether the action must be taken, and a consequence of not taking the action within a preset time period.

In certain instances, the sending may be practiced by streaming data from a server to the cooking appliance, storing data from the server to the cooking appliance, storing data from the server to a central hub located in a same house as the cooking appliance, etc.

In certain instances, the central hub may be connected to multiple networked appliances.

In certain forms of the invention, a cooking program annotation system is provided. Processing resources include at least one processor. The processing resources are configured to at least: receive source cooking program video; execute an annotation program module configured to generate annotations pertaining to the source cooking program video, the annotations specifying at least one of an action to be taken by a user, a time at which the action is to be taken, an indication of whether the action must be taken, and a consequence of not taking the action within a preset time period; execute a cooking program builder to package into one or more cooking program distributables a digitized version of the source cooking program video, or a portion thereof, together with instructions corresponding to the annotations, the one or more cooking program distributables being executable or interpretable by or for a suitably configured cooking appliance; and store the one or more cooking program distributables to a non-transitory computer readable storage location.

In certain instances, the source cooking program video may be received in real time or in substantially real time, and/or the source cooking program video may include prerecorded content.

In certain instances, the processing resources may be further configured to publish the one or more cooking program distributables to a server accessible by one or more remotely located cooking appliances.

In certain forms of the invention, a method of annotating a cooking program is provided. Source cooking program video content is received. Annotations pertaining to the source cooking program video are generated, with the annotations specifying at least one of an action to be taken by a user, a time at which the action is to be taken, an indication of whether the action must be taken, and a consequence of not taking the action within a preset time period. A digitized version of the source cooking program video, or a portion thereof, together with instructions corresponding to the annotations, are packaged into one or more cooking program distributables. The one or more cooking program distributables are executable or interpretable by or for a suitably configured cooking appliance. The one or more cooking program distributables are stored to a non-transitory computer readable storage location.

In certain forms of the invention, an interactive cooking system is provided. A cooking device (e.g., at a home, residential, or other location) is operable by a user. An electronic device is in communication with the cooking device. The electronic device is configured to process audio and/or video content instructing the user how to operate the cooking device (e.g., to prepare a preselected food item). An electronic device in some cases may be retrofitted to an existing cooking device.

In certain instances, the audio and/or video content may be received from a remote repository of smart cooking programs, a library of smart cooking programs stored on the electronic device and/or the cooking device, etc.

In certain instances, the electronic device may be a book with embedded electronics programmed or configured such that audio and/or video is reproduced from the book itself and/or from the cooking device when it is detected that a page has been manually turned. Similar functionality may be provided to an e-book or e-reader in operable communication with the cooking device. In some cases, printed material may be provided and the electronic device may provide a means by which the user can indicate that a next step is being, or is ready to be, taken.

In certain instances, the communication between the cooking device and the electronic device enables commands to be sent from the electronic device to the cooking device, status information to be sent from the cooking device to the electronic device, status information to be sent from the electronic device to the cooking device, and/or the like.

In certain forms of the invention, a server that is connectable to a plurality of cooking appliances located in respective remote home locations via a network is provided. The server includes at least one processor, as well as a non-transitory storage location storing a plurality of downloadable cooking programs. Each said cooking program stores related cooking video content and associated cooking instructions. A network interface is configured to cooperate with the at least one processor to communicate with cooking appliances to cause a requested one of said cooking programs to be displayed on and selectively take at least partial control over operation of a corresponding requesting cooking appliance.

The examples, features, aspects, and advantages described herein may be combined in any suitable combination or sub-combination to realize yet further forms of the invention.

### BRIEF DESCRIPTION OF THE DRAWINGS

FIG. 1 is a schematic view of an example intelligent cooking appliance in accordance with a form of the invention;

FIG. 2 is a schematic view of another example intelligent cooking appliance in accordance with a form of the invention;

FIG. 3 is a block diagram showing certain components of an example interactive cooking network environment in accordance with a form of the invention;

FIG. 4 is an example structure for a cooking program, demonstrating how the cooking program could be distributed to an intelligent cooking appliance, in accordance with a form of the invention;

FIG. 5 is an example user interface for an intelligent cooking appliance in accordance with a form of the invention;

FIGS. 6a-6c help demonstrate a form of interactivity between an example intelligent cooking appliance and an example cooking program in accordance with forms of the invention;

FIG. 7 is a flowchart showing an example process for controlling an intelligent cooking appliance in accordance with a form of the invention;

FIG. 8 is a flowchart showing a more detailed example process for automatically controlling an intelligent cooking appliance in accordance with a form of the invention;

FIG. 9 is a schematic view of an example system for building an interactive cooking program to be used with an example intelligent cooking appliance in accordance with a form of the invention; and

FIG. 10 is a flowchart showing an example process for annotating a cooking program for, and distributing the cooking program to, an example intelligent cooking appliance, in accordance with a form of the invention.

### DETAILED DESCRIPTION

The following description is provided in relation to several examples which may share common characteristics, features, etc. It is to be understood that one or more features of any one example may be combinable with one or more features of other examples. In addition, single features or a combination of features may constitute an additional embodiment(s).

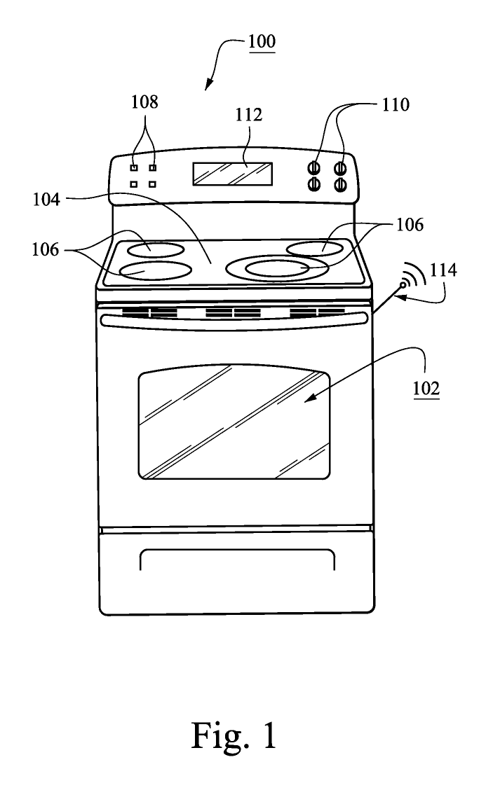

Referring now more particularly to the drawings in which like reference numerals indicate like parts throughout the several views, FIG. 1 is a schematic view of an example intelligent cooking appliance 100 in accordance with a form of the invention. The example cooking appliance 100 in FIG. 1 includes an oven 102 and a cook top or range 104, including a plurality of burners and may be used in home/residential locations in certain scenarios. Although the example cooking appliance 100 in FIG. 1 is shown as including these components, it will be appreciated that the techniques disclosed herein may be used in connection with a variety of cooking appliances that may include one or more of a variety of the same or different cooking elements including, for example, coffee makers, burners, cook tops, ovens or ranges, microwaves, etc. Referring once again to FIG. 1, a plurality of controls 108 are provided for controlling features of the oven 102, and a plurality of controls 110 are provided for controlling features of the burners 106 on the cook top 104. Digital buttons and control knobs are shown in the FIG. 1 example for controlling features of the oven 102 and the features of the cook top 104, respectively, although other control mechanisms are of course possible in different forms of the invention.

A display device 112 is shown. The display device 112 may be any suitable display device including, for example, a liquid crystal display (LCD) device or other flat panel display. It may have touch screen capabilities, e.g., as provided via a resistive type or capacitive type touch sensitive panel integral with or disposed over the underlying display. In certain example cooking appliances, some or all of the controls 108 and/or 110 may be replaced and/or supplemented with soft buttons provided by a user interface accessible via the display device 112. As discussed in greater detail below, the display device 112 may in certain forms of the invention also serve as a means for displaying an interactive cooking program.

A network connection 114 also is provided to the example cooking appliance 100 shown in FIG. 1. The network connection 114 may be a wired or wireless connection to a network router in the location in certain examples, and the router may provide a connection to the outside world (e.g., via the Internet). In certain other examples, the network connection 114 may be connected to a central hub in a house, residential setting, or the like, that serves a focal or coordination mechanism for a plurality of smart appliances. The hub may, in turn, be connected to a router and have a connection to the Internet. Wired connections may include, for example, Ethernet connections, USB connections, and/or the like. Wireless connections, on the other hand, may be established via a suitable 802.11 protocol, Bluetooth, and/or the like.

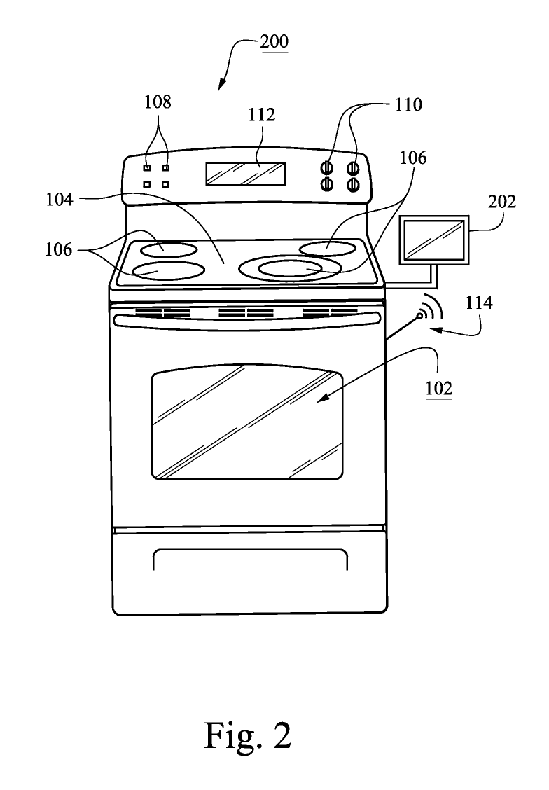

FIG. 2 is a schematic view of another example intelligent cooking appliance 200 in accordance with a form of the invention. The FIG. 2 example is similar to the FIG. 1 example. However, the FIG. 2 example cooking appliance 200 includes a secondary display device 202. As with the first display device 112, the secondary display device 202 may be a touch screen in certain forms of the invention. It also may or may not be a part of a user interface to the cooking appliance 200. The first display device 112 and/or the secondary display device 202 may separately or together provide elements of the cooking program. For instance, the main content (e.g., in the form of a audiovisual programming) may be output via the secondary display device 202, whereas certain more limited instructions may appear on the first display 112 including, for example, simple or summary instructions (e.g., set temperature to X, set timer for Y, check the turkey now), status information (a countdown as to the amount of programming content left, timer information, etc.), or vice versa. In certain other forms of the invention, main programming content may be displayable on one of the display devices, and ancillary information pertaining to, for instance, a cooking or food preparation technique, a dictionary or glossary, hints or tips, etc., may be displayed on the other. In such cases, the content on the two screens may be related to one another such that, for example, a corresponding definition or short video clip for a particular concept that may be relevant to the first screen may be shown on the second screen.

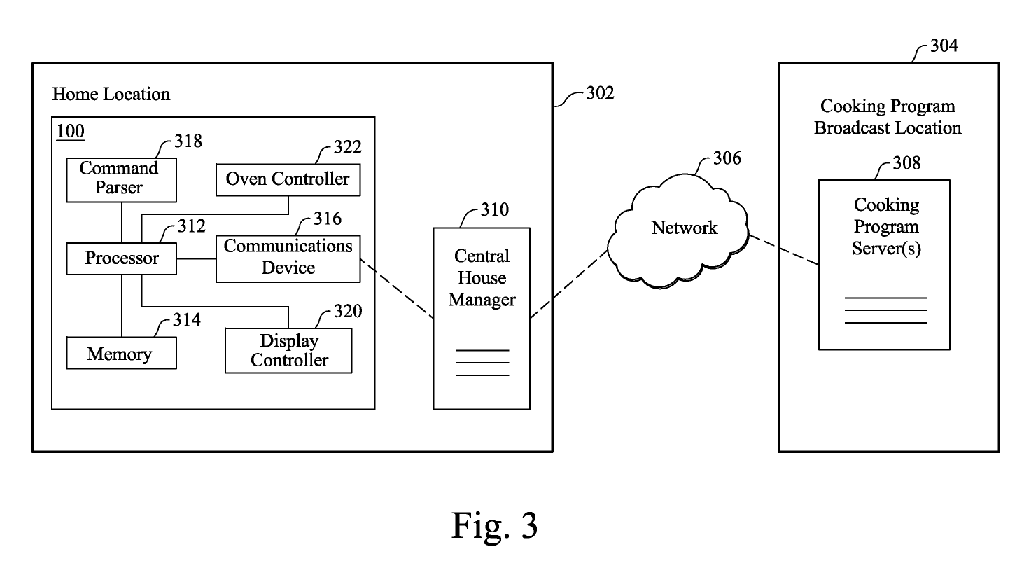

FIG. 3 is a block diagram showing certain components of an example interactive cooking network environment in accordance with a form of the invention. The FIG. 3 example block diagram shows that the cooking appliance 100 is provided to a home location 302. The home location 302 is connected to a remote cooking program broadcast location 304 via a network 306 (e.g., the Internet). The cooking program broadcast location 304 includes one or more cooking program servers 308 for serving cooking program content through the network 306 to the home location 302. In the FIG. 3 example, a central house manager 310 is connected to the network 306. One or more intelligent appliances may be connected to the central house manager 310. This includes the example cooking appliance 100 and may also include other devices such as, for example, refrigerator/freezer units, coffee makers, televisions, telephones, and/or other devices.

Example components of the example cooking appliance 100 will now be described. As shown in the FIG. 3 illustration, the example cooking appliance 100 includes at least one processor 312 and a memory 314. The memory 314 may be a combination of volatile and/or non-volatile memory in different forms of the invention. For instance, RAM, ROM, flash memory, and/or the like may be used in different forms of the invention. The processor 312, working with the memory 314, may execute instructions for the user interface alluded to above and described in greater detail below. A communications device 316 may be in wired or wireless connection to the central house manager 310. Data from the cooking program server(s) 308 received over the network 306 by the central house manager 310 may be communicated to the communications device 316. The processor 312 may take this information from the communications device 316 and determine what should be done, e.g., by using a command parser 318. The command parser 318 may, for example, indicate that video content is to be displayed along with corresponding instructions, in which case the processor 312 may instruct the display controller 320 to output appropriate information to the display device 112. The instructions may include an indication of where (e.g., specifying the device(s) or indicator(s), absolute or relative positions on the device(s), etc.), when (e.g., specifying a relative or absolute time, when an action has been taken or has not been taken, etc.), and how (e.g., specifying font, size, style, transparency, kerning, etc.) text and/or video is to be displayed. The commands interpreted by the command parser 318 may also, or in the alternative, provide instructions to actually cause the oven to react or cease reacting. In such a case, the processor 312 may take the commands and pass the to the oven controller 322, thereby causing the oven to take a certain action (e.g., temperature to increase/decrease, timer to start, alerts to sound/flash, turn on/off oven, etc.). It will be appreciated that some or all of these and/or other components may be implemented as software, hardware, firmware, or any suitable combination thereof, in different forms of the invention.

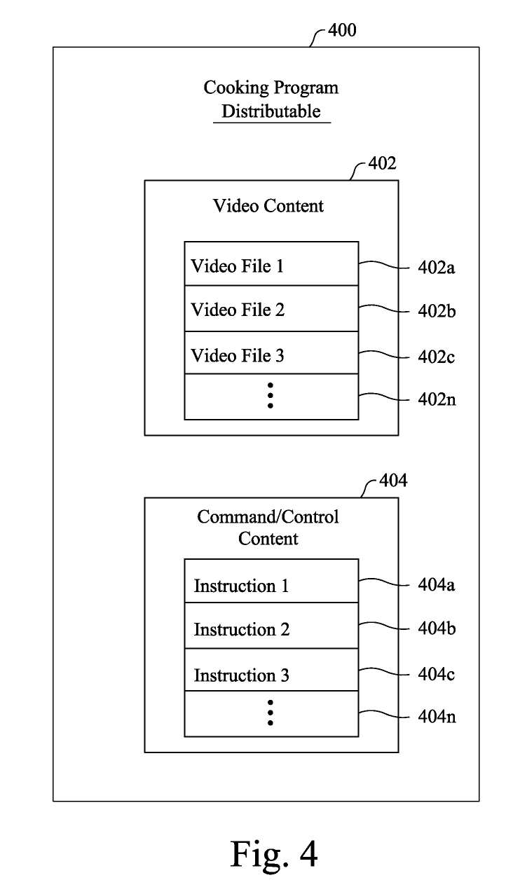

FIG. 4 is an example structure for a cooking program, demonstrating how the cooking program could be distributed to an intelligent cooking appliance, in accordance with a form of the invention. That is, FIG. 4 shows a shell cooking program distributable 400 that may be distributed from the cooking program server(s) 304 to the home location 302. As shown in the FIG. 4 example, the cooking program distributable 400 includes video content 402 and command/control content 404. Each of these segments may be broken down into smaller parts. For instance, the video content 402 may be broken down into plural video files 402a-402n. Similarly, the command/control content 404 may be broken down into instructions 404a-404n. It will be appreciated that there need not necessarily be a one-to-one correspondence between the video content parts and the command/control content parts.

The video content itself may be provided in accordance with any suitable format. Suitable video files include, for example, AVIs, MPEGs, WMVs, Flash media, etc. The command/control content similarly may be provided in any suitable format. In certain examples, the command/control content may be organized as one or more XML or other tag-based files. Tags may be provided indicating when actions are to be taken, what actions are to be taken, the consequence of a user not taking an action, etc., which may be the same as or similar to the instructions indicated above. Simple control logic thus may be built in an extensible way and distributed in an easily parsed or interpreted manner. It will be appreciated that other interpreted or compiled languages may be used for the command/control content and that a tag-based system is not necessary for all implementations of the invention.

In certain forms of the invention, commands or instructions may be processed through a central manager or hub and distributed to the correct cooking appliance. For instance, the central manager or hub may be responsible for receiving the distributable, determining from header information which cooking appliances are implicated, uncompressing any compressed content, and sending instructions (e.g., display instructions, cooking instructions, etc.) to the appropriate appliance(s).

In certain cases, it may be desirable to provide default triggers. Such default triggers may be provided on a program-by-program basis and/or on a global basis for the appliance. For instance, a macro-level instruction may be provided to stop all heating if a smoke detector integral with the appliance or otherwise connected to a location's central manager or hub detects smoke. As another example, a default macro-level instruction may be to stop heating an oven if an internal temperature surpasses a predetermined threshold. This macro-level instruction may be overridden for a program basis, e.g., to lower the predetermined threshold. It will be appreciated that program triggers may be independent of macro-level triggers. For instance, there may not be a corresponding macro-instruction for a particular program-level instruction. As a perhaps more concrete example, it may be desirable to employ a humidity sensor when steaming vegetables and specify a threshold level of desired moisture, whereas a corresponding macro-level instruction may not necessarily be provided.

In certain cases, the distributable may be tangibly stored on a non-transitory computer readable storage medium. The non-transitory computer readable storage medium may be on a central server, on the cooking appliance, on a device operably connected to the cooking appliance, etc.

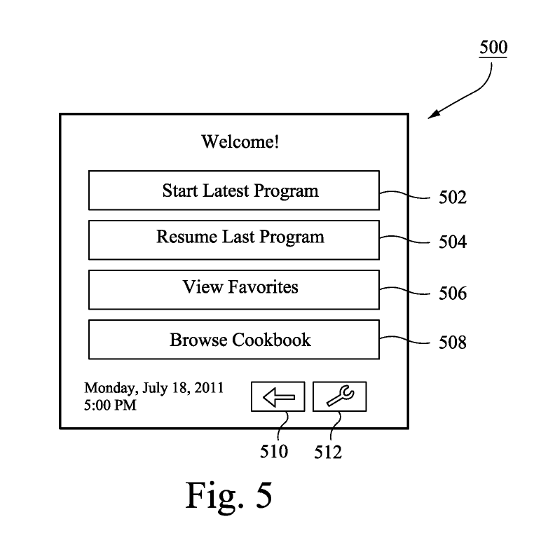

FIG. 5 is an example user interface for an intelligent cooking appliance in accordance with a form of the invention. As indicated above, the example display screen 500 shown in FIG. 5 may be output to the main display device 112 or an ancillary display device (e.g., the secondary display 202 in the FIG. 2 example). In certain forms of the invention, a removable display device may be at least temporarily docked on the cooking appliance and optionally removed therefrom when in use. In still other forms of the invention, the example display screen 500 may be provided on another device such as, for example, a laptop computer, a tablet, a smart phone, a PDA, a television, or any other suitable display device. When a docked device or other external device is used, a network interface between the device and the appliance may be provided, e.g., so as to potentially coordinate activities such as, for example, taking automatic actions with respect to the cooking appliance, displaying instructions on a different display of the cooking appliance, taking measurements, receiving time updates, etc. In such cases, the link between the external device and the appliance may be a direct wireless or wired connection therebetween. In different forms of the invention, however, an external device may indirectly communicate with a cooking appliance, e.g., through a router or central house manager. When the external device is a desktop or portable computer, tablet, smart phone, or the like, a software application may be installed thereon to facilitate such communications in certain example instances. In other example instances, the devices may connect to a website or other network location to access the content.

Referring once again to the FIG. 5 example display screen, a series of soft buttons are provided for the user. Each soft button represents a different action the user can take, e.g., by using a touch screen interface. Of course, it will be appreciated that other input mechanisms may be used (such as, for example, a dedicated keypad or series of buttons, a mouse, a keyboard, one or more control knobs, etc.). In any event, a first button 502 enables a user to start the latest cooking program. When the user depresses this button, the most recently published cooking show may be displayed. A second button 504, by contrast, enables a user to resume the last program that the user was watching in the event that it was interrupted (e.g., because it was temporarily paused by the user, there was a power or network interruption, it is a part of a series of programs, the appliance “timed out” after a period of inactivity, the cooking program itself paused the playback or shut down the appliance, etc.).

A user may also flag favorite cooking programs, e.g., as they are watched, after they are watched or tried, etc. Alternatively, or in addition, a list of favorite cooking programs may be maintained based on rankings, number of views, or some other metric, by the user or by multiple users. Thus, it will be appreciated that multiple “favorites” lists may be maintained in certain example instances. The lists may be maintained locally and/or on a centrally accessible server (e.g., remote from the home location 302 and possibly at the cooking program broadcast location 304). In certain examples, a database may be provided, with the database having an entry for each cooking program. Associated fields may be maintained for tracking, for example, number of ratings, numerical scores (e.g., on a scale of 1-5, 1-10, four stars, or on some other basis), binary “like/dislike” designations, number of views, number of comments (potentially with associated links to a table storing such comments), etc. User controls may be implemented in instances where commenting is enabled, e.g., such that a moderator may approve, disapprove, or edit postings; where only verified or registered users have posting privileged; etc. In this regard, a database of cooking appliance users may be maintained. In any event, a third button 506 may enable a user to access a list of the favorite programs, regardless of how the list is generated, how many different lists are maintained, and/or where they are stored. A suitable interface may be provided to a commercially available or proprietary dedicated cooking appliance social networking site or forum, etc., to enable users to comment, rate, and/or engage in other activities, e.g., using the cooking appliance directly or a separate network-enabled device.

A fourth button 508 may enable a user to browse prior shows that have already been published, downloaded to the cooking appliance, and/or made available for download to the cooking appliance. The favorites list may be a subset of the items viewable by browsing the cookbook. That is, in certain forms of the invention, the cookbook may represent a master list of all cooking programs currently available (whether already downloaded or ready for new download or streaming), whereas the favorites may represent a subset of this master list, as controlled by the user. It is noted that online recipe websites, mobile device applications (or so-called “apps”), and/or the like also may serve as a source of smart recipes, e.g., in that they may be retrieved and/or converted as necessary or desirable in connection with the example embodiments disclosed herein.

As alluded to above, a database of cooking appliance users may be maintained. This database may include, for example, a name or nickname for a user and an indication of the cooking appliance(s) the user has. If the cookbook is accessed, the user database may be consulted so as to determine a list of programs to which the user may have rights. In certain instances, all users may have access to all cooking programs. In certain other instances, the cooking programs that a user may access may be limited or filtered by virtue of the type of cooking appliance that the user has and intends to use (e.g., so that a user with an intelligent microwave does not have access to cooking programs for an intelligent range or cook top). In still other instances, a user may be able to access cooking programs that are designated as being “free” cooking programs. Thus, a user may be allotted a certain number of “free” cooking programs but may have to pay a fee to access additional content or content designated as “premium” or pay-to-play content.

A navigation button 510 may enable the user to exit out of the main cooking system 500, e.g., in the event that the user wants to use the appliance in a conventional manner. A tools button 512 may enable the user to provide or check settings of the cooking appliance. For instance, the user may enter a name, a current date/time, manage favorites, set rules for automatically downloading new cooking programs as they become available or according to a certain schedule or based on certain filters (e.g., vegetarian dishes only, lactose-free meals, Kosher or Kosher-style only), etc. In certain examples, a user may be able to upload “photo favorites” to a commonly accessible server or make such photos available in a distributed manner using their own devices as severs, with such photos being, for example, live shots of a person cooking, culinary creations in their various stages of completion, and/or the like.

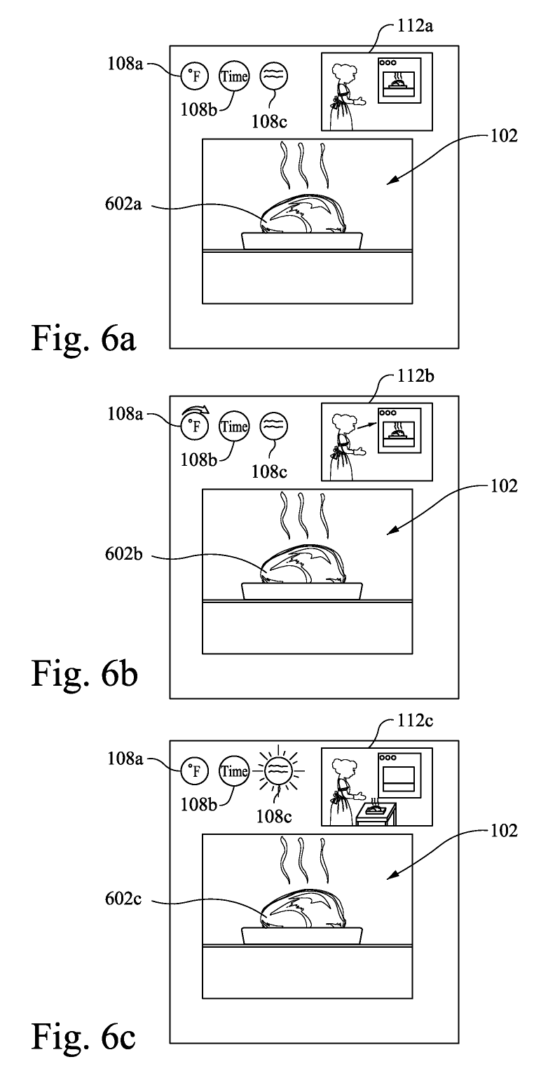

FIGS. 6a-6c help demonstrate a form of interactivity between an example intelligent cooking appliance and an example cooking program in accordance with forms of the invention. Referring first to FIG. 6a, the portion 112a of the program is displayed on the display device 112. The cook at home inserts the turkey in a first state 602a into the oven 102, following the leads provided in the cooking program. The temperature is set via the temperature control 108a, and the time is set via the time control 108b.

In FIG. 6b, the next portion 112b of the program indicates that the turkey is to be checked and, since it is not cooking fast enough, the temperature of the oven 102 is to be increased. The cook at home follows this lead and likewise is instructed to increase the temperature via the temperature control 108a. An indicator may light up on the oven 102 at this time. In certain instances, the temperature may be automatically increased. It also may be possible to check the temperature of the oven interior and/or the turkey in its second state 602b via a thermometer inserted therein. A customized recommendation therefore can be made for the home cook based on the actual conditions. In this way, the cooking program may provide specific guidance and instructions to the cook and/or intelligent appliance. However, the appliance itself may act based on the information it has available to it to help reduce the likelihood of operator error. Similarly, it may be possible to provide a combination of general and custom instructions specifically suited for a particular environment, as cooking conditions may vary on a variety of factors including, for example, type of appliance, ambient temperature and/or humidity conditions, altitude, etc. If extra time is needed, the cooking program may pause itself, optionally displaying a suitable message (e.g., “Program Temporarily Paused” or “Waiting for Turkey to Cook Completely,” etc.), while the user is waiting. The device may be a multitasking device in certain example implementations of the invention and thus may allow the user to access other features such as, for example, an online glossary, video tips/tricks as to how to perform various cooking techniques or know when an item is done cooking, browse the Internet, send comments to the cooking program instructor, etc. Some actions cannot be taken automatically (e.g., to rotate or flip an item being cooked), however. In such cases, a “manual action required” flag may be set and transmitted with the instructions, indicating that a user must take an action and specifying a consequence of inaction (e.g., an audio and/or visual alarm may be triggered, temperature may be reduced to a warm setting until the correct manual action is detected, etc.).

In FIG. 6c, the final portion 112c of the program indicates that the turkey is ready and thus is to be removed from the oven or needs to be turned in the oven. Accordingly, checks similar to those described above may be performed, e.g., to determine if the temperature of the turkey 602c has reached the desired level for the desired amount of time. If this is the case, and/or if the user does not act within a predetermined amount of time, an audible alarm 108c may be sounded. The audible alarm 108c may be accompanied by other visual indicators in certain example instances, e.g., depending on the control codes associated with the cooking program. Further checks may be performed, e.g., to determine whether the turkey actually has been removed. This may be accomplished in certain implementations by providing optical detection means, a weight sensor or strain gauge on a cooking rack, or in any other suitable manner. It will be appreciated that these and/or other actions may take place because manual intervention is necessary, e.g., to remove and/or turn the item being cooked.

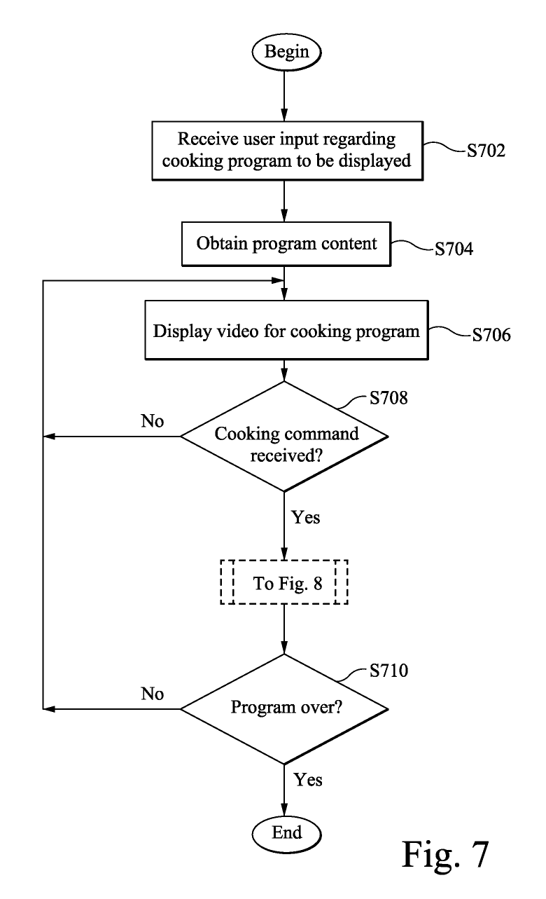

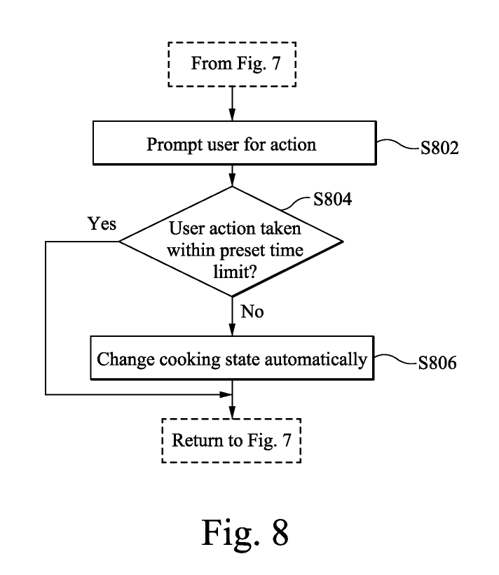

FIG. 7 is a flowchart showing an example process for controlling an intelligent cooking appliance in accordance with a form of the invention. In step S702, input is received regarding the cooking program to be displayed. For instance, the user may select a cooking program using the interface described above in connection with FIG. 5 from a display device integral with or connected to the smart cooking appliance, using a device removed therefrom, or using some other external device. Program content may be obtained on the appropriate device in step S704. This may include accessing the appropriate content. In certain instances, the content may be stored locally on the appliance, in the central hub in the house or other location, on the device, etc. In certain other instances, the information may be downloaded or streamed from a server. The information to be downloaded may include one or more video files and/or one or more instructions files. These files may be packaged together (e.g., into a single distributable file such as that described above in connection with FIG. 4) or distributed as separate components. Video for the cooking program may be received in step S706. If a cooking command is not received in step S708, the video may continue to play. On the other hand, if a cooking command is in fact received in step S708, the command may be appropriately processed (e.g., in accordance with the example process shown in and described in connection with the FIG. 8 flowchart). After the command is processed, a check may be performed in step S710 to determine whether cooking program is over. If it is not, then additional video may be displayed. However, if the program is over, the user may in certain instances be asked to complete a questionnaire or feedback form regarding the program, e.g., giving the user the opportunity to rate the program, ask questions, post comments, etc. The user may also be returned to a main menu in certain instances.

FIG. 8 is a flowchart showing a more detailed example process for automatically controlling an intelligent cooking appliance in accordance with a form of the invention. In particular, if an instruction is received, a user may be prompted to take an appropriate action in step S802. A timer may be included to help determine whether the user has taken an appropriate action with a preset time limit (e.g., which may be specified within the instruction file received). If it is determined in step S804 that the desired action has not been taken within the preset time limit, then the cooking state may be changed automatically in step S06. If the action has been taken by the user, or once the action is taken automatically, then the process may return to FIG. 7.

In certain examples of this invention, multiple checks may be performed prior to the prescribed action being taken automatically. For instance, in certain examples, prompts of potentially increasing attention-getting levels may be actuated. For instance, a textual prompt may be displayed after a first predetermined amount of time, blinking indicators may be displayed after a second predetermined amount of time, audio alerts may be activated after a third predetermined amount of time, etc. These warning actions or alerts may be specified in the instructions or may be set as defaults that may or may not be overridden in different implementations.

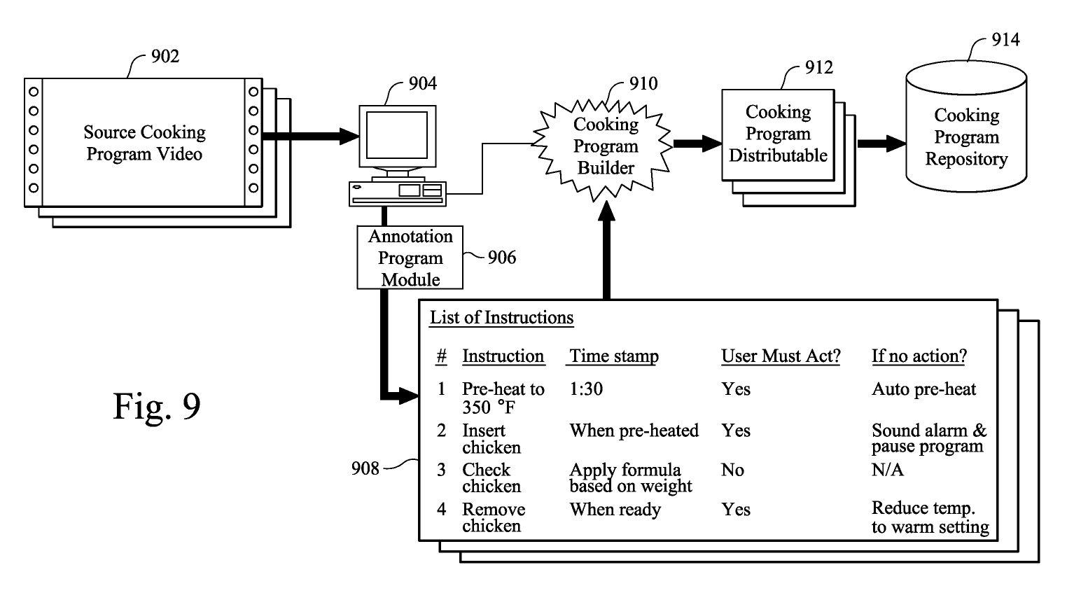

FIG. 9 is a schematic view of an example system for building an interactive cooking program to be used with an example intelligent cooking appliance in accordance with a form of the invention. As shown in FIG. 9, source cooking program video 902 may be provided to a computer 904. The source cooking program video 902 may be recorded and/or digitized live in certain example scenarios. However, in certain other example scenarios, the source cooking program video 902 may be recorded, digitized, and subsequently processed. An annotator may use a annotation program module 906 (which may be stored on or accessible by the computer 904) to provide annotations to source cooking program video 902. These annotations may be simple statements of ingredients, instructions of how to prepare those ingredients, instructions regarding how to operate a cooking appliance, etc.

The annotations may be stored to a list of instructions 908 that helps control the cooking appliance, both in terms of operating the appliance itself and in terms of providing informational content to supplement the cooking program. The list of instructions 908 includes an ordered list of instructions, as well as simple statements of each instruction. An indication of when each instruction is to trigger an action also may be included. These times may be absolute or relative measures. For instance, an instruction to pre-heat an oven to a specified temperature may occur at a known and thus absolute period relative to the cooking program. By contrast, different ovens may pre-heat at different rates. Thus, a subsequent instruction as to when an item should be placed in an oven may be a relative time, e.g., once it is detected that the oven is pre-heated. As still another example, a time may be based on a calculation. The calculation may be, for example, a weight of the item to be cooked multiplied by a number of minutes per pound. And in still another example, gathered measurements may guide the timing. For instance, the time may be specified as a function of a number of minutes after an internal temperature of an item reaches a predetermined threshold.

In addition to the specified times, a flag may be set as to whether a user should or must act based on the instruction. In this vein, a consequence of inaction may be specified. For example, a user may be required to pre-heat the oven. The consequence of a user not acting may be that the oven is made to automatically pre-heat itself to the instructed temperature. As another example, the user may be required to insert the item into the oven. A consequence of the user not acting within a specified time period may involve, for example, activating specified alarms and/or pausing the program for the user to act. A more optional action like checking an item to determine whether it is done may be advisable but may not be absolutely necessary. Thus, the flag indicating whether the user must act may be set to “no,” “false,” or the like.

The list of instructions 908 and the source cooking program video 902 may then be passed to a cooking program builder 910, which may be a module stored on or accessible by the computer 904. The cooking program builder 910 may be used to split the cooking program into logical segments and package or associate digitized video with corresponding instructions. As indicated above, a tag-based language may be implemented for this purpose. The cooking program builder 910 may output one or more cooking program distributables 912. The one or more cooking program distributables 912 may, in turn, be stored to a cooking program repository 914 for subsequent download or transmission to end-users. In addition, or in the alternative, the one or more cooking program distributables 912 may be streamed to users watching live and/or to user having set their appropriately configured devices to automatically download certain programs.

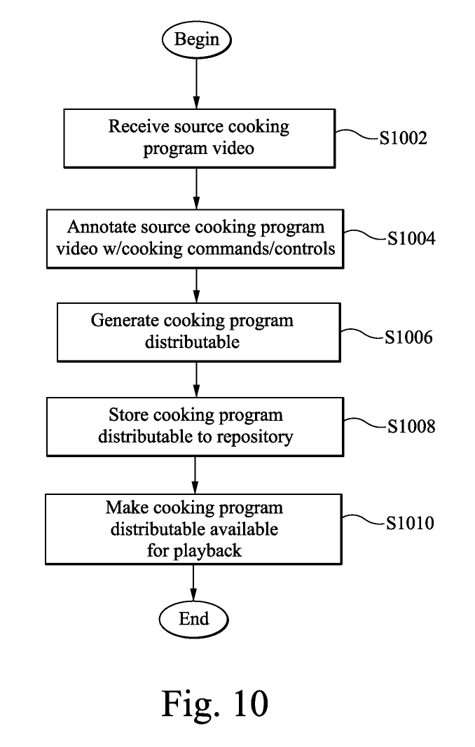

FIG. 10 is a flowchart showing an example process for annotating a cooking program for, and distributing the cooking program to, an example intelligent cooking appliance, in accordance with a form of the invention. A source cooking program video is received in step S1002. The video may be received in real time, with a delay, or the video may be pre-recorded. The source cooking program video may be annotated with cooking commands and/or controls in step S1004. These commands and/or control may be visual prompts as to how, when, and where information is to be displayed for a user, and/or commands to take a particular action (e.g., as steps in a recipe). As indicated above, the instructions may be made to include a time at which they are to be displayed, an indication as to whether an instruction is required, a response if an action is taken or not taken with a preset time period, etc. A cooking program distributable is generated in step S1006. The distributable may include one or more video files and one or more files of instructions, optionally synchronized with the one or more video files. The distributable may be stored to a repository for subsequent download or streaming in step S1008, and the cooking program distributable may be made available for playback in step S1010. That is, the cooking program distributable may be published to an online repository of programs, a corresponding entry in an online cookbook or listing of programs may be created, etc. When an entry in an online cookbook or listing of programs is created, the listing may be browsable by users' end devices. In some cases, the information may be pushed to the user's end device if that user is a subscriber, e.g., to a certain category of cooking programs into which the particular distributable has been classified, to all cooking programs, etc.

In certain example embodiments, it may be possible to adapt old or existing programs for distribution in accordance with the example techniques disclosed herein. The techniques shown in and described in connection with FIGS. 9 and/or 10 may be used for these purposes in certain instances. In certain examples, the general structure of a show may be known. Thus, it may be possible to use speech-recognition and/or text-recognition techniques to create annotations or suggested annotations for a program. Speech-recognition accuracy may be improved by training a speech-recognition engine over time or in advance with multiple programs. Improved accuracy may be particularly desirable, for example, when a celebrity chef has a strong accent, frequently uses a common ingredient or technique, etc. Similarly, text-recognition accuracy may be improved by programming a text-recognition engine to look for known colors and/or shapes of blobs or leader boards that oftentimes encapsulate text in programs. These techniques may be desirable, for example, when converting existing content into distributable programs suitable for use with the intelligent cooking appliances described herein.

In certain instances, chefs at home may be able to engage with a celebrity chef, e.g., through one- or two-way communications. This may, for example, help replicate a cooking experience at home and/or across many homes. In certain scenarios, a direct interface to the celebrity chef may be provided, e.g., when the program is being broadcast live. In other instances, the program may be pre-recorded, but a chef may be on-hand to answer questions and send answers as if the program were being aired live. In certain example instances, the celebrity chef or others may receive email messages, text or picture messages (e.g., SMS or MMS messages), or other communications. These messages may be sent through a proprietary system accessible via the intelligent appliance or suitably configured device, or via standard communications lines. One or more persons may address select ones of such communications, e.g., answering common questions, providing a replay of a certain technique, adjusting the program to resolve a common issue, change the lighting or orientation of a camera, etc. Thus, it may be possible for a chef or others to receive inputs and make adjustments accordingly, thereby providing an increased sense of involvement for end-users.

It will be appreciated that the techniques described herein may result in various advantages. For instance, the techniques described herein may provide a more interactive version of cookbooks and cooking programs, potentially leading to increased enjoyment and immersion in the cooking experience, e.g., on the part of home or residential cooks. A sense of belonging and ownership in the cooking community (e.g., if feedback is possible, questions can be asked, a ratings system is implemented, a social network is created, etc.) may be provided to at-home chefs, along with a sense of connection to the celebrity chef. A cook may have reduced apprehensions about trying out a new recipe or even cooking/baking, given the number of warnings that may be raised, actions that may be taken automatically, etc. Similarly, the likelihood of a successful meal being created may be increased. This may be advantageous for novice at-home cooks, or even experienced at-home cooks who have previously attempted and “failed” in creating a desired meal.

Cross-marketing and partnering opportunities may be opened up as between cooking shows/videos, celebrities, food suppliers, appliance manufacturers, etc., inasmuch as the appliances may be used in a variety of home/residential and/or other settings. Interactive marketing also becomes a possibility in certain forms of this invention, e.g., as the marketing material may be seen by many home cooks. For example, when a particular ingredient or cooking utensil is used, an advertisement for the same may be displayed. Annotations may be provided in the instruction file to display an advertisement for a particular product, at a particular time, and/or for a particular amount of time. The instruction may indicate a specific manufacturer's product in certain instances relevant to what is happening in the video. In certain other instances, the instruction may indicate a type of product (e.g., olive oil, spatulas, etc.) and then may select an advertisement from a database of advertisements. The selection of the advertisement may be controlled so that a specific product appears on a particular program, so that products are cycled through at regular intervals, so that certain products are displayed at specified percentages of the time, so that certain products are provided for a given geographic area, etc. In certain instances, the advertisements may be time sensitive, regional, or otherwise limited. Companies seeking to have their products advertized may pay premiums for broader or different exposure.

Even people who love to cook can sometimes have trouble coordinating multiple items for one meal in such a way that they are all completed at the “right time.” One advantage of certain example forms of the invention, however, is that it may become easier to coordinate the cooking of multiple items with multiple different cook times. For instance, it may be possible to leverage the example techniques disclosed herein to orchestrate the preparation of different foods when multi-rack baking and/or timed meal coordination is necessary or desirable. For instance, recipes may call for putting meat in the oven at 3 pm, then bread at 5 pm, than vegetables and a pie at 5:30 pm, etc., so that everything is done at 6:30 pm. In certain instances, it may be possible to facilitate the interaction between the appliance and multiple recipes at the same or overlapping times. A multitasking processor may be provided in certain instances to facilitate this sort of appliance to multiple recipe interactivity.

The automated techniques of certain examples may leverage known automated broiling, automated baking, and/or other techniques commercially available in the appliances manufactured by the assignee of the instant invention.

Although certain example embodiments have been described in relation to an oven, it will be appreciated that the techniques disclosed herein may be applied to a variety of different cooking appliances, e.g., in home or residential settings. For instance, the techniques disclosed herein may be applied to ovens, cook tops, microwaves, coffee makers, toasters, steamers, rice cookers, Dutch ovens, blenders, mixers, juicers, and/or the like.

While the invention has been described in connection with what are presently considered to be the most practical and preferred examples, it is to be understood that the invention is not to be limited to the disclosed examples, but on the contrary, is intended to cover various modifications and equivalent arrangements.

What is claimed is:

1. A home or residential cooking appliance, comprising:
one or more controls operable by a user to adjust settings of the cooking appliance;
a display; and
processing resources including at least one processor configured to:
present a user interface to the user using the display,
access a cooking program distributable based on a user selection from the user interface,
obtain video content and at least one instruction from the cooking program distributable,
cause the video content obtained from the cooking program distributable to be displayed on the display, and
control the cooking appliance in response to the instructions.

2. The cooking appliance of claim 1, wherein each said instruction specifies an action to be taken by a user and a time at which the action is to be taken.

3. The cooking appliance of claim 2, wherein the time at which the action to be taken is specifiable as either an absolute time reference linked to the video content, or a variable time based on a condition of the cooking appliance and/or item to be cooked.

4. The cooking appliance of claim 3, wherein the variable time is based on a calculation.

5. The cooking appliance of claim 2, wherein each said instruction further specifies whether a user must act based on the instruction.

6. The cooking appliance of claim 5, wherein each said instruction further specifies a consequence of a user not acting in response the instruction within a specified time period.

7. The cooking appliance of claim 6, wherein the consequence includes an instruction to the at least one processor of the cooking appliance to adjust one or more settings thereof to reduce or otherwise mitigate the likelihood of damage to an item being cooked.

8. The cooking appliance of claim 2, wherein the at least one processor is further configured to generate an audible and/or visual alert each time an action is to be taken.

9. The cooking appliance of claim 2, wherein the at least one processor is further configured to adjust one or more settings of the cooking appliance without direct human intervention in the event that the action to be taken by the user is not taken within a specified time limit.

10. The cooking appliance of claim 9, wherein the at least one processor is further configured to adjust the one or more settings of the cooking appliance that would have been adjusted if the user had taken action in accordance with the instruction.

11. The cooking appliance of claim 9, wherein the at least one processor is further configured to adjust settings of the cooking appliance to reduce or otherwise mitigate the likelihood of damage to an item being cooked.

12. The cooking appliance of claim 1, wherein the user interface includes an input area through which the user is able to send a message to a remote site.

13. The cooking appliance of claim 12, wherein the message is an email message.

14. A cooking system comprising, at each of a plurality of home locations:
a cooking appliance operable by a user;
a display device operably connectable to the cooking appliance and configured to display a user interface;
a network communications device configured to obtain cooking video content and associated cooking instructions from a remote location over a network connection to a network in response to a user selection from the user interface;
a display controller configured to cause the video content obtained by the network communications device to be output to the display device; and
a command parser configured to interpret the associated cooking instructions so that the associated cooking instructions are selectively (a) output to the display device and (b) used to control the cooking appliance.

15. The cooking system of claim 14, wherein each said home location includes a central house manager connecting the cooking appliance and/or display device to the network.

16. The cooking system of claim 15, wherein the central house manager includes the command parser and/or display controller.

17. The cooking system of claim 14, further comprising:
a server located remote from the home locations and being connected to each of the home locations via the network, the server storing a plurality of downloadable cooking programs, each said cooking program storing related cooking video content and associated cooking instructions,
wherein the network communications device of each said cooking appliance is configured to access individual ones of the cooking programs.

18. The cooking system of claim 17, wherein the cooking programs are downloadable to the cooking appliances.

19. The cooking system of claim 17, wherein the server is configured to stream the cooking programs to the cooking appliances.

20. The cooking system of claim 14, wherein each said instruction specifies at least one of an action to be taken by a user, a time at which the action is to be taken, an indication of whether the action must be taken, and a consequence of not taking the action within a preset time period.

21. The cooking system of claim 20, wherein the time at which the action to be taken is specifiable as either an absolute time reference linked to the video content, or a variable time based on a condition of the cooking appliance and/or item to be cooked.

22. The cooking system of claim 20, wherein the consequence includes a command to the cooking appliance to adjust a setting thereon independent of user action.

23. The cooking system of claim 20, wherein the cooking appliance is controllable to generate an audio and/or visual indication that an action must be taken.

24. A non-transitory computer readable storage medium tangibly storing instructions that, when executed or interpreted, cause a cooking appliance to at least:
display a video segment on a display device in operable communication with the cooking appliance;
display, on the display device, one or more recipe steps to a user of the cooking appliance at time periods specified by the instructions; and
selectively override one or more settings of the cooking appliance if the user does not act in accordance with a command included in the instructions within a time period specified by the instructions.

25. The non-transitory computer readable storage medium of claim 24, wherein the instructions are stored in a tag-based format.

26. The non-transitory computer readable storage medium of claim 24, wherein the instructions are stored in an XML file.

27. A method of controlling a cooking appliance, the method comprising:
receiving a request for a cooking program from the cooking appliance; and
matching the request for the cooking program with a corresponding cooking program distributable, the cooking program distributable including video content and instructions as to how the cooking appliance is to be operated; and
sending the corresponding cooking program distributable to the cooking appliance,
wherein the cooking appliance is configured to process the cooking program so as to (a) cause the video content to be displayed thereon, and (b) control the cooking appliance in accordance with the instructions.

28. The method of claim 27, wherein each said instruction specifies at least one of an action to be taken by a user, a time at which the action is to be taken, an indication of whether the action must be taken, and a consequence of not taking the action within a preset time period.

29. The method of claim 27, wherein the sending is practiced by streaming data from a server to the cooking appliance.

30. The method of claim 27, wherein the sending is practiced by storing data from the server to the cooking appliance.

31. The method of claim 27, wherein the sending is practiced by storing data from the server to a central hub located in a same house as the cooking appliance.

32. The method of claim 31, wherein the central hub is connected to multiple networked appliances.

33. A cooking program annotation system, comprising processing resources including at least one processor, the processing resources being configured to at least:
receive source cooking program video;
execute an annotation program module configured to generate annotations pertaining to the source cooking program video, the annotations specifying at least one of an action to be taken by a user, a time at which the action is to be taken, an indication of whether the action must be taken, and a consequence of not taking the action within a preset time period;
execute a cooking program builder to package into one or more cooking program distributables a digitized version of the source cooking program video, or a portion thereof, together with instructions corresponding to the annotations, the one or more cooking program distributables being executable or interpretable by or for a suitably configured cooking appliance; and
store the one or more cooking program distributables to a non-transitory computer readable storage location.

34. The system of claim 33, wherein the source cooking program video is received in real time or in substantially real time.

35. The system of claim 33, wherein the source cooking program video includes prerecorded content.

36. The system of claim 33, wherein the processing resources are further configured to publish the one or more cooking program distributables to a server accessible by one or more remotely located cooking appliances.

37. A method of annotating a cooking program, the method comprising:
receiving source cooking program video content;
generating annotations pertaining to the source cooking program video, the annotations specifying at least one of an action to be taken by a user, a time at which the action is to be taken, an indication of whether the action must be taken, and a consequence of not taking the action within a preset time period;
packaging into one or more cooking program distributables a digitized version of the source cooking program video, or a portion thereof, together with instructions corresponding to the annotations, the one or more cooking program distributables being executable or interpretable by or for a suitably configured cooking appliance; and
storing the one or more cooking program distributables to a non-transitory computer readable storage location.

38. An interactive cooking system, comprising:
a cooking device operable by a user; and
an electronic device in communication with the cooking device,
wherein the electronic device is configured to process audio and/or video content instructing the user how to operate the cooking device.

39. A server connectable to a plurality of cooking appliances located in respective remote home locations via a network, the server comprising:
at least one processor;
a non-transitory storage location storing a plurality of downloadable cooking programs, each said cooking program storing related cooking video content and associated cooking instructions; and
a network interface configured to cooperate with the at least one processor to communicate with cooking appliances to cause a requested one of said cooking programs to be displayed on and selectively take at least partial control over operation of a corresponding requesting cooking appliance.
